(19) United States
(12) Patent Application Publication
(10) Pub. No.: US 2004/0066458 A1
(43) Pub. Date: Apr. 8, 2004

(54) Imaging system

(76) Inventors: Hiroyuki Kawamura, Tokyo (JP); Hironori Hosino, Tokyo (JP); Takeshi Fukuda, Tokyo (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/614,088

(22) Filed: Jul. 8, 2003

(30) Foreign Application Priority Data
Jul. 12, 2002 (JP) P 2002-204187

(51) Int. Cl. H04N 5/225

(52) U.S. Cl. 348/216.1; 348/229.1

(57) ABSTRACT

An imaging system according to the invention is to supply a sharper image while restraining the blooming even in the case of having a strong illuminant such as an oncoming headlamp at night. It includes an IR lamp for radiating an infrared ray forward, a CCD camera for taking an image in the forward direction and converting the image into an electric signal, and an image processing unit for varying the signal accumulating time of the CCD camera at a predetermined cycle and continuously and periodically supplying the images of different light exposure amount. The image processing unit sets a mask for adjusting the brightness level between the images of different light exposure amount in the ODD fields and the EVEN fields, on the image of the higher brightness level in the ODD fields.

### BACKGROUND OF THE INVENTION

1. Field of the Invention

The present invention relates to an imaging system using a CCD camera.

2. Description of the Related Art

The conventional imaging system includes, for example, that one as shown in FIG. 12. In FIG. 12, this system includes a CCD camera 101 as imaging means, a DSP (Digital Signal Processor) 103 as an image processing unit, and a CPU 105.

The CPU 105 is connected to the DSP 103 through a multiplexer 107, so as to receive a signal from a shutter-speed setting switch 109. The shutter-speed setting switch 109 can set the shutter speed for the ODD (odd number) field and the shutter speed for the EVEN (even number) field respectively.

Namely, the set state of the shutter-speed setting switch 109 is read out by the CPU 105 and the shutter-speed set values of the respective fields are encoded and supplied. A field pulse signal shown in FIG. 13 is supplied from the DSP 103 and when the output signal is high, the shutter-speed set value on the EVEN side is supplied to an input terminal for shutter-speed setting of the DSP 103 through the multiplexer 107, while when it is low, the shutter-speed set value on the ODD side is supplied there. The imaging system as shown in FIG. 12 can set various shutter-speeds depending on the respective fields.

Generally, when taking an image with a CCD camera, at an automatic shutter-speed having the same shutter speed in the ODD fields as well as in the EVEN fields, when a bright illuminant comes into the dark surroundings as shown in FIG. 14, the vicinity of the illuminant disappears due to the blooming (halation). FIG. 14 shows an image ahead of a car taken with an in-vehicle CCD camera, while illuminating the forward direction with an infrared ray from an IR lamp that is the infrared ray illuminating means, during the run at night. The vicinity of a bright illuminant such as an oncoming headlamp and an illumination of a gas station disappears owing to the blooming. This is because the automatic shutter speed controls the whole screen output in an average darkness. Although the shutter speed can be set higher so as to restrain the blooming (halation), the sight of the background is fully lost in this case, as shown in FIG. 15.

On the contrary, the control of FIG. 12 for changing the shutter speed in every field is a so-called double exposure control, and various shutter speeds are set depending on the respective fields. Thus, a bright image and a dark image are alternatively supplied; a portion invisible because of darkness can be seen in a bright image (in the ODD fields in this case) and a portion invisible because of blooming (halation) can be seen in a dark image (in the EVEN fields in this case).

The images of the respective fields are alternatively supplied and they can be displayed on a monitor as a sharp image as shown in FIG. 16.

In the above simple double exposure control, however, one of the fields is for the bright image and the other is for the dark image, which causes flicker on the monitor disadvantageously, resulted from the alternative display of the bright image and the dark images.

On the other hand, there is an imaging system disclosed in Japanese Patent Publication No. 97841/1995, as shown in FIG. 17. The imaging system comprises a camera 113 having an image pickup device 111 and a processor 115.

FIG. 18 is a schematic view of the image processing by the imaging system of FIG. 17. A through image in this drawing means a direct output from the image pickup device 111 of the camera 113 and a memory image means a signal of the most recent field once stored in an image memory 117.

In the through image, a main subject at an illuminating time becomes black shadow in the ODD fields where the shutter speed is set fast, while the background is blown out in the EVEN fields where it is set slow. The memory image is formed by a signal delayed by the period of one field, and therefore, blown-out highlights and black shadow area occur in the fields different from the through image. Accordingly, by a proper combination of the through image and the memory image, an output image in the bottom portion of FIG. 18 can be obtained.

The combination of the through image and the memory image, however, is obtained by superimposing an image partially selected from the through image upon an image partially selected from the memory image, resulting in a state of jointing the images of different light exposure amount. Accordingly, flicker can be prevented on the whole screen, similarly in the simple double exposure control, but a boundary of the through image and the memory image becomes artificial disadvantageously.

The invention is to provide an imaging system capable of supplying a sharper image.

### SUMMARY OF THE INVENTION

An imaging system according to the invention comprises infrared ray illuminating means for radiating an infrared ray, imaging means for taking an image of a place illuminated by the infrared ray illuminating means and converting the image into an electric signal, and an image processor for varying signal accumulating time of the imaging means at a predetermined cycle and continuously and periodically forming images of different light exposure amount, wherein the image processor sets a mask for adjusting a brightness level between the images of different light exposure amount.

In the imaging system according to the invention, the image processor sets the mask on the image of the higher brightness level, of the images of different light exposure amount.

In the imaging system according to the invention, the image processor adjusts the brightness level, according to the brightness of the mask or a format of each dot forming the mask.

In the imaging system according to the invention, the image processor changes the mask, according to an average gradation on the whole screen formed by the images of different light exposure amount, hence to adjust the brightness level.

In the imaging system according to the invention, the infrared ray illuminating means, the imaging means, and the image processor are provided in a car, the infrared ray illuminating means illuminates an outside of the car with the infrared ray, and the imaging means takes an image of the outside of the car.

According to the invention, the infrared ray illuminating means can radiate the infrared ray. The imaging means can take an image of the place illuminated by the infrared ray illuminating means and convert the image into an electric signal. The image processor can vary the signal accumulating time of the imaging means at a predetermined cycle and continuously and periodically supply the images of different light exposure amount.

The image processor can set a mask for adjusting the brightness level between the images of different light exposure amount.

According to the double exposure control, it is possible to show the portion dark and invisible in a bright image as well as the portion invisible because of the blooming (halation) in a dark image. Further, the brightness level between the both images is adjusted by setting the mask, so as to restrain a gradation difference. Therefore, it is possible to prevent from generating the boundary and the flicker on the output image due to a difference of the light exposure amount thereby supplying image.

According to the invention, since the image processor sets the mask on the image of the higher brightness level, of the images of different light exposure amount, it is possible to restrain a gradation difference between the images of different light exposure amount by lowering the brightness level of the above image, thereby supplying a sharper image assuredly.

According to the invention, the image processor can adjust the brightness level according to the brightness of the mask or the format of the dots forming the mask. Accordingly, it is possible to lower the brightness level between the images of different light exposure amount assuredly.

According to the invention, the image processor can change the mask according to the average gradation on the whole screen formed by the images of different light exposure amount. Accordingly, it is possible to adjust the brightness level between the images of different light exposure amount thereby supplying a sharper image.

According to the invention, the infrared ray illuminating means, the imaging means, and the image processor can be provided in a car, the infrared ray illuminating means can illuminate an outside of the car with the infrared ray, and the imaging means can take an image of the outside of the car. Accordingly, while restraining the blooming (halation) due to the oncoming headlamp and the like, it is possible to show a dark portion sharply and brightly and confirm the outside of the car thanks to the sharp image output.

### BRIEF DESCRIPTION OF THE DRAWINGS

FIG. 1 is a schematic view of a car to which a first embodiment of the invention is adopted.

FIG. 2 is a block diagram of imaging means and an image processor, according to the first embodiment.

FIG. 3 is a flow chart, according to the first embodiment.

FIG. 4 shows a mask pattern according to the first embodiment; A is a first pattern view, B is a second pattern view, C is a third pattern view, D is a fourth pattern view, and E is a fifth pattern view.

FIG. 5A is a view for use in describing scanning of an image synchronization signal and image data and FIG. 5B is a view for use in describing scanning of superimpose data, according to the first embodiment.

FIG. 6A is a table indicating the kinds of the color data and FIG. 6B is a table indicating the array of the color data, according to the first embodiment.

FIG. 7A is an image output view of white 100% and FIG. 7B is an enlarged view of the portion surrounded by a white line on the top right of A, according to the first embodiment.

FIG. 8A is an image output view of white 50% and FIG. 8B is an enlarged view of the portion surrounded by a white line on the top right of A, according to the first embodiment.

FIG. 9A is an image output view of white 0% and FIG. 9B is an enlarged view of the portion surrounded by a white line on the top right of A, according to a second embodiment.

FIG. 10 is a block diagram of the imaging means and the image processor according to the second embodiment of the invention.

FIG. 11 is a flow chart according to the second embodiment.

FIG. 12 is a block diagram according to the conventional example.

FIG. 13 is an output view of a field pulse, according to the conventional example.

FIG. 14 is an output image view at the general shutter speed, according to the conventional example.

FIG. 15 is an output image view at a high shutter speed, according to the conventional example.

FIG. 16 is an output image view showing the blooming (halation) phenomenon.

FIG. 17 is a block diagram according to the other conventional example.

FIG. 18 is a view of image formation, according to the other conventional example.

### DESCRIPTION OF THE PREFERRED EMBODIMENT

[First Embodiment]

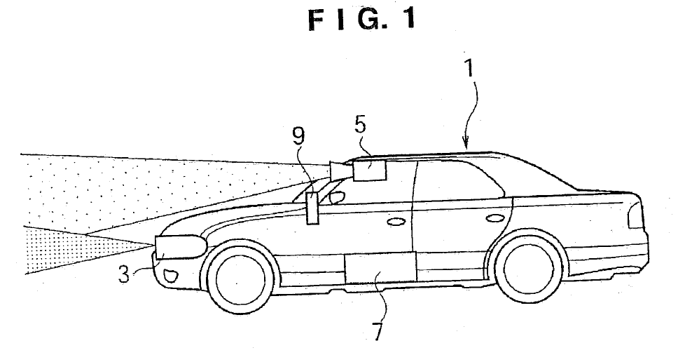

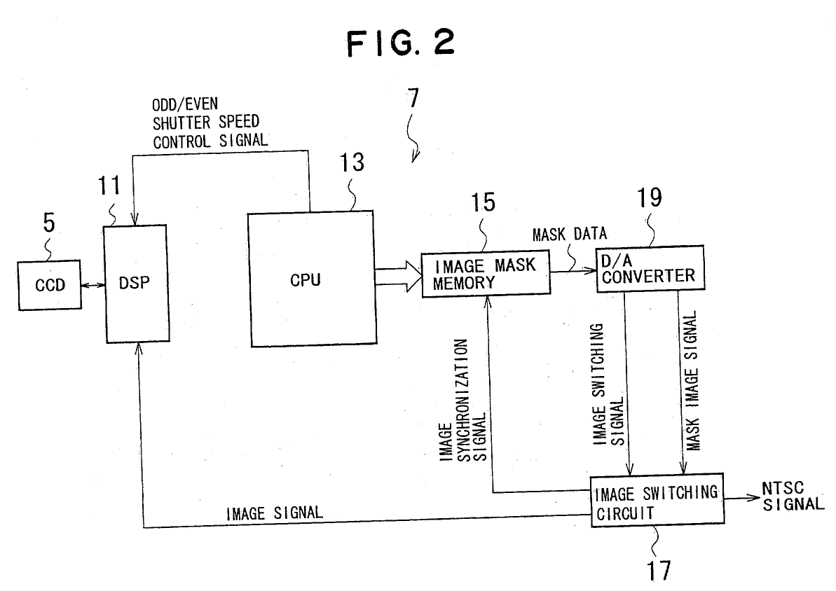

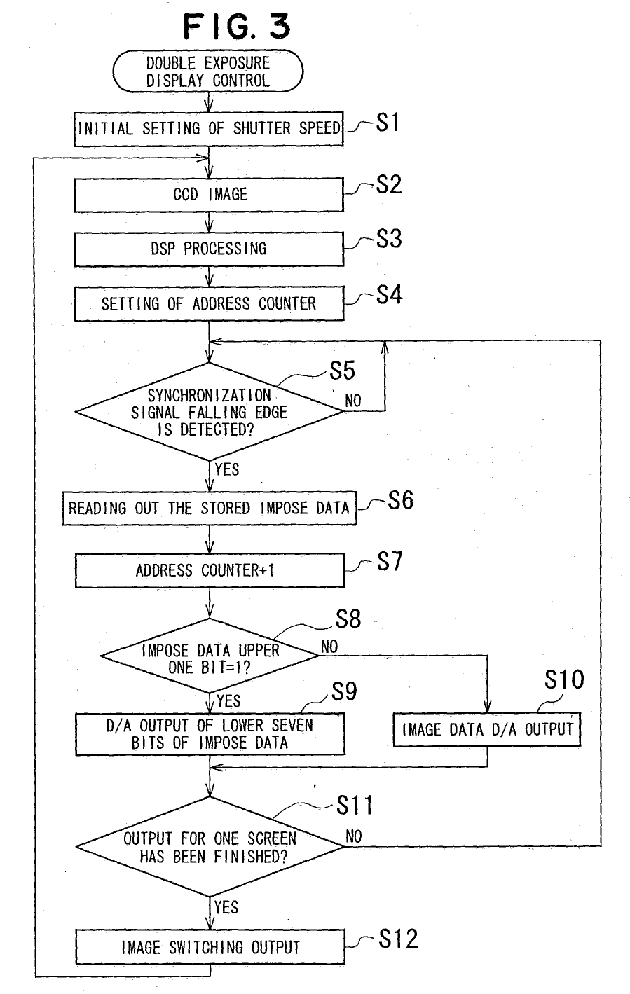

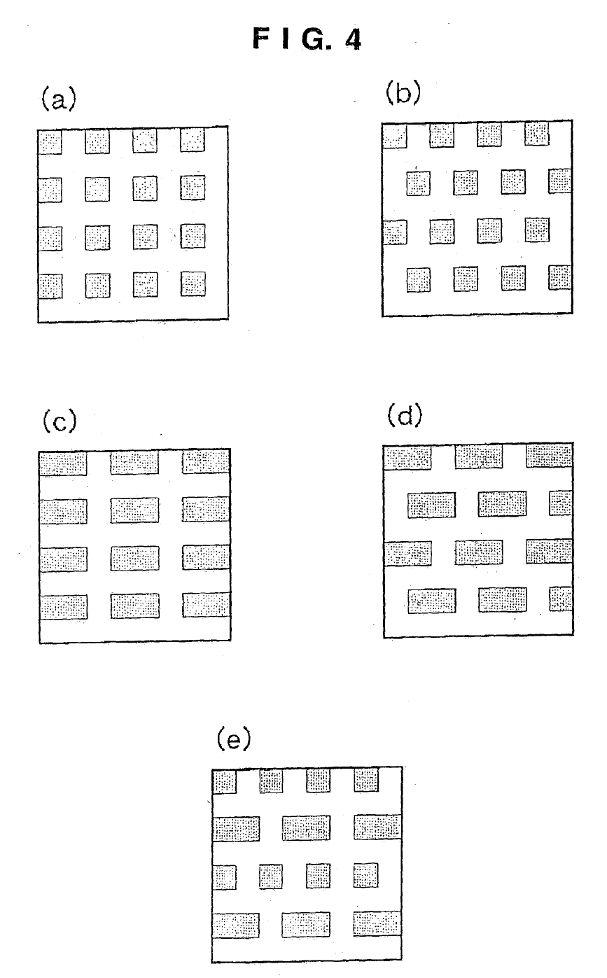

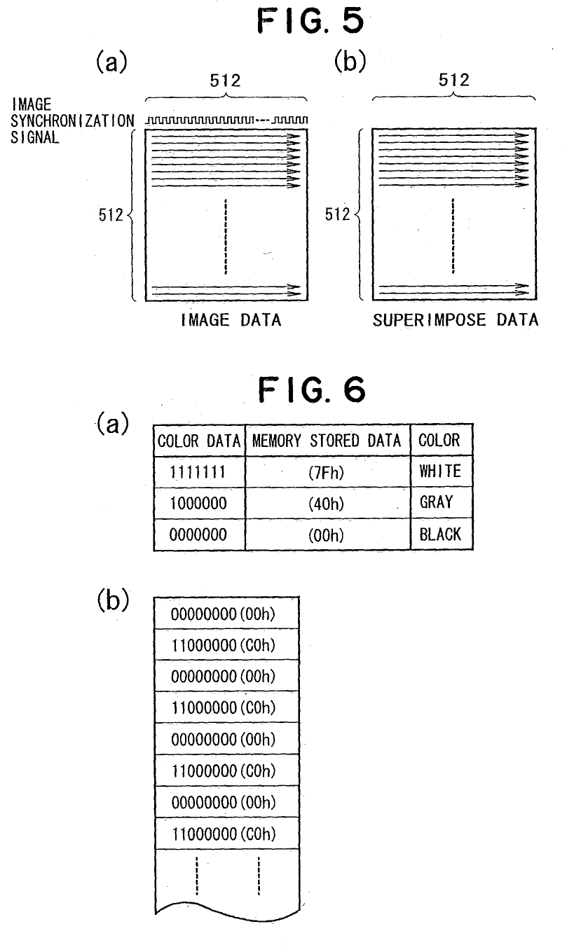

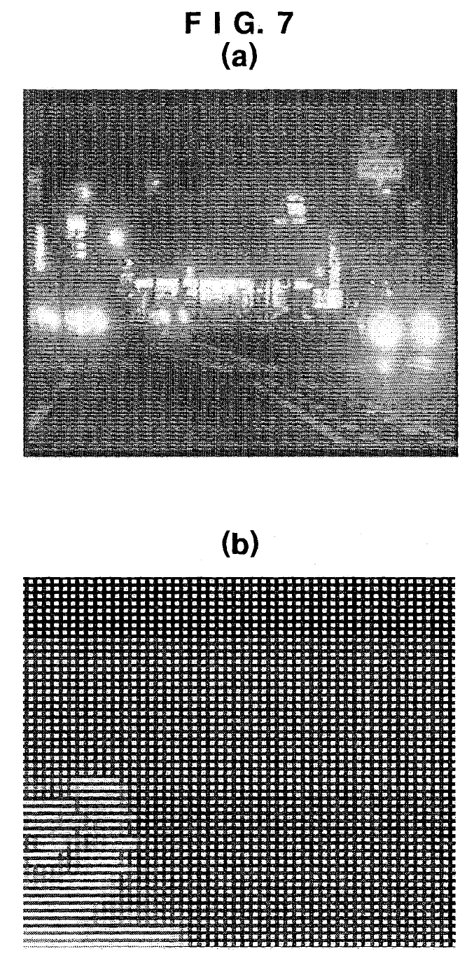

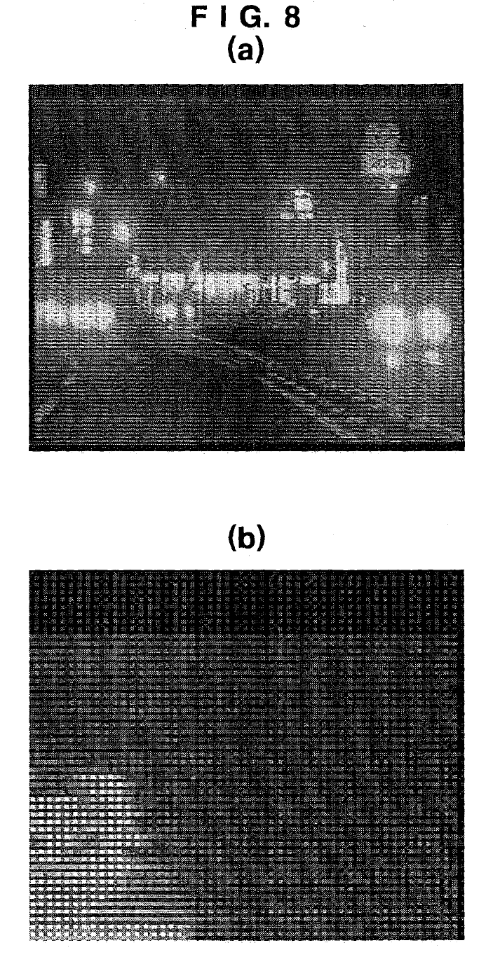

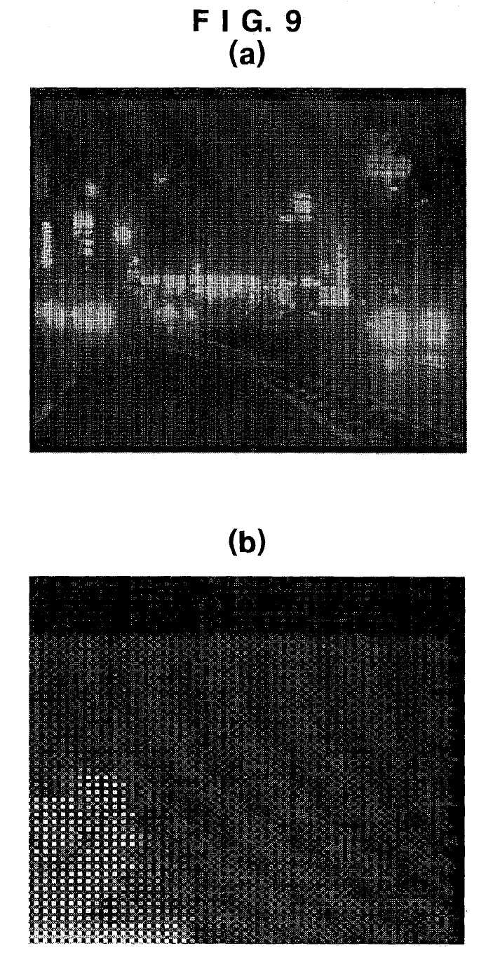

FIG. 1 to FIG. 9 show a first embodiment of the invention. FIG. 1 is a schematic view of a car to which the first embodiment of the invention is adopted, FIG. 2 is a block diagram showing imaging means and an image processor according to the first embodiment, and FIG. 3 is a flow chart according to the first embodiment. FIG. 4 shows a mask pattern according to the first embodiment; A is a first pattern view, B is a second pattern view, C is a third pattern view, D is a fourth pattern view, and E is a fifth pattern view. FIG. 5A is a view for use in describing scanning of an image synchronization signal and image data and FIG. 5B is a view for use in describing scanning of superimpose data. FIG. 6A is a table indicating the kinds of the color data and FIG. 6B is a table indicating the array of the color data. FIG. 7A is an image output view of white 100% and FIG. 7B is an enlarged view of the portion surrounded by a white line on the top right of A. FIG. 8A is an image output view of white 50% and FIG. 8B is an enlarged view of the portion surrounded by a white line on the top right of A. FIG. 9A is an image output view of white 0% and FIG. 9B is an enlarged view of the portion surrounded by a white line on the top right of A.

As shown in FIG. 1, an imaging system according to the first embodiment of the invention is to be applied to a car, and the car 1 comprises an IR lamp 3 as the infrared ray illuminating means, a CCD camera 5 as the imaging means, an image processing unit 7 as the image processor, and further a headup display 9.

The IR lamp 3 is to illuminate the forward direction ahead of the car 1 in the running direction with an infrared ray, in order to enable the camera to take an image at a dark place, for example, at night. The CCD camera 5 is to take an image ahead of the car 1 in the running direction, illuminated by the infrared ray, and to convert it into an electric signal. The electric signal in this case is to be converted by a photo diode of a photosensitive unit in the CCD camera 5. The image processing unit 7 varies the signal accumulating time of the CCD camera 5 at a predetermined cycle and supplies the images of different light exposure amount continuously and periodically.

The signal accumulating time is a signal accumulating time for every pixel. Varying the signal accumulating time at a predetermined cycle means that by varying the number of the pulses discharging the unnecessary electric charges accumulated in every pixel, the time accumulated is varied as a result and it means the electronic shutter operation. Continuously and periodically supplying the images of different light exposure amount means that the shutter speed is set for every field of the ODD and the EVEN, according to the electronic shutter operation and that the images of the respective fields read out at the respective shutter speeds are continuously and alternatively supplied in every 1/60 sec.

In the high speed shutter in which the shutter speed is fast, a dark portion is difficult to show but a bright portion can be seen sharply, while in the low speed shutter in which the shutter speed is slow, a bright portion is saturated and blown out but a dark portion can be seen sharply.

The image processing unit 7 sets a mask for adjusting the brightness level of the images of different light exposure amount. The images of different light exposure amount means the respective images in the ODD field and the EVEN field under the double exposure control. The image processing unit 7 sets the mask at the image having the higher level of brightness, of the images of different light exposure amount. In this embodiment, a bright image at a low shutter speed is for the ODD field and the mask is set on the images of the ODD fields. The brightness level of the images in the ODD fields can be lowered by setting of the mask.

The image processing unit 7 adjusts the brightness level according to the setting of the brightness of the mask or the format of the dots forming the mask, for example, the size of the dot and its array. The brightness of the mask or the size and the array of the dots will be described later.

As illustrated in FIG. 2, the image processing unit 7 comprises a memory 15 for image mask, an image switching circuit 17, and a D/A converter 19, in addition to the DSP 11 and the CPU 13.

The DSP 11 is to convert the signal from the CCD camera 5 into a digital signal and supply it as an analog image signal.

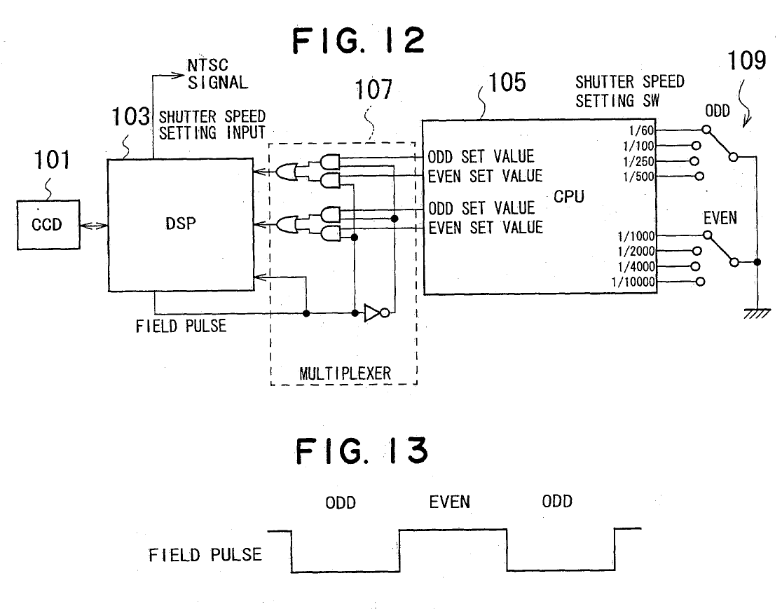

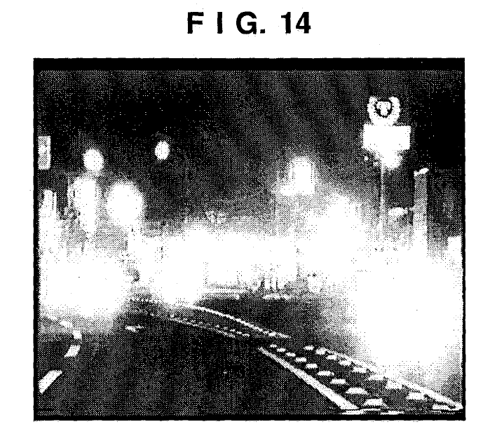

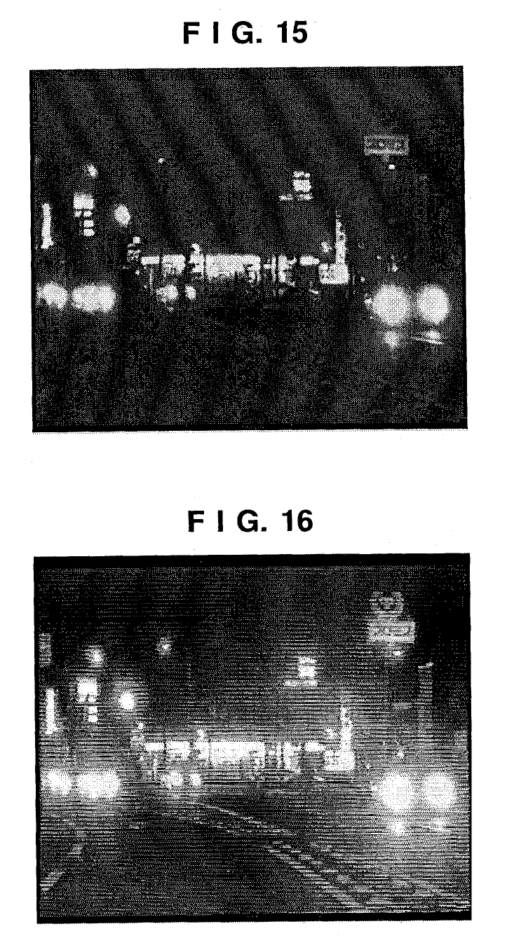

The CPU 13 is to perform various calculations as well as to control the shutter speed for every ODD field and EVEN field, in the same structure as described in FIG. 12. Namely, a shutter speed control signal is to be supplied from the CPU 13 to the DSP 11.

The CPU 13 writes a mask pattern (mask data) into the image mask memory 15.

The image mask memory 15 has the same capacity as the image data supplied from the DSP 11 and it is, for example, 512×512 bytes.

The image signal output from the DSP 11 is supplied to the image switching circuit 17. The image switching circuit 17 creates an image synchronization signal and supplies it to the image mask memory 15.

The image mask memory 15 supplies the data for the mask which has been written, according to the image synchronization signal supplied from the image switching circuit 17, to the D/A converter 19. The D/A converter 19 converts the input mask data into an analog signal, hence to create a mask image signal. The D/A converter 19 simultaneously supplies the image switching signal to the image switching circuit 17. The image switching circuit 17 switches the image signal from the DSP 11 and the mask image signal from the D/A converter 19 according to the image switching signal and supplies the image, for example, as an NTSC signal.

FIG. 3 shows a flow chart of the first embodiment. The imaging system according to the first embodiment basically conforms to the double exposure control, and according to the flow chart of FIG. 3, the processing of “initial setting of the shutter speed” is performed at first in Step S1. In Step S1, for example, the shutter speed on the side of the ODD field is set low as mentioned above, and the shutter speed on the side of the EVEN field is set high.

In this embodiment, the shutter speed on the side of the ODD field is set at 1/60 sec., the shutter speed on the side of the EVEN field is set at 1/1000 sec., and the operation proceeds to Step S2. The respective shutter speeds may take the other values than the above. Alternatively, the side of the ODD field may be set at the high shutter speed and the side of the EVEN field may be set at the low shutter speed.

In Step S2, the processing of “CCD imaging” is performed. In Step S2, the shutter speed control signal on the side of the ODD field and the shutter speed control signal on the side of the EVEN field which have been set in Step SI are supplied from the CPU 13 to the DSP 11.

Then, the CCD camera 5 takes an image according to the driving signal and the signal charge is performed on the whole pixels of the photo diode of the photosensitive unit of the CCD camera 5. On the side of the ODD field, the signal charge of each pixel of the odd number vertically in every other line is read out at 1/60 sec., of the whole pixels of the photo diode of the photosensitive unit. On the side of the EVEN field, the signal charge of each pixel of the even number is read out at 1/1000 sec. and the operation proceeds to Step S3.

In Step S3, the processing of “DSP” is performed. In Step S3, the signal charge read out by the CCD camera 5 is taken in, converted into digital signal by the A/D converter, subjected to signal processing and output, and the operation proceeds to Step S4.

In Step S4, the processing of “setting of address counter” is performed. In Step S4, the address counter is set, the address for taking out the data of the DSP 11 and the image mask memory 15 is set, and the operation proceeds to Step S5.

In Step S5, the processing of “synchronization signal falling edge detection” is performed. In Step S5, it is checked whether the falling edge of the image synchronization signal to be supplied from the image switching circuit 17 to the image mask memory 15 has been detected or not. The falling of this image synchronization signal becomes the timing of reading out the mask data, or the stored impose data written into the image mask memory 15. In Step S5, when the falling edge of the image synchronization signal is not detected, the above check whether it is detected or not will be repeated in Step S5. When the falling edge of the image synchronization signal is detected in Step S5, the operation proceeds to Step S6.

In Step S6, the processing of “reading out the stored impose data” is performed. In Step S6, the mask data written into the image mask memory 15 is read out at the address having been set in Step S4 at the timing of the falling edge of the image synchronization signal having been detected in Step S5, and the operation proceeds to Step S7.

In Step S7, the processing of “address counter+1” is performed. In Step S7, the address for reading out the next mask data from the image mask memory 15 is determined and the operation proceeds to Step S8.

In Step S8, the check of “whether the impose data upper bit=1 or not” is performed. In Step S8, whether the upper one bit of the mask data or the superimpose data is 1 or 0 is checked; when it is 1, the operation proceeds to Step S9, while when it is 0, the operation proceeds to Step S10. This check is performed in order to read out the superimpose data when the upper one bit is 1 because the mask is put on the screen of one frame only in the ODD fields.

In Step S9, the processing of “D/A output of lower seven bits of impose data” is performed. In Step S9, the data for the lower seven bits specified as described below as the color data of the superimpose data is supplied from the image mask memory 15 to the D/A converter 19. The D/A converter 19 converts the data of the lower seven bits into an analog signal and supplies the signal to the image switching circuit 17 as a mask image signal, and the operation proceeds to Step S11.

In Step S10, the processing of “image data D/A output” is performed. In Step S10, the image data from the DSP 11, instead of the superimpose data from the image mask memory 15, is supplied to the image switching circuit 17, and the operation proceeds to Step S11.

In Step S11, the check of “whether the output for one screen has been finished or not” is performed. In Step S11, it is checked whether the superimpose data or the image data has been supplied or not, in all the addresses. When it has not been supplied for one screen (NO), Step S5 to Step S11 will be repeated. When the superimpose data or the image data for one screen has been supplied and the mask image (mask data) is formed (YES), the operation proceeds to Step S12. The above processing is not always performed in a time-sharing way, but the output from a memory for output is always performed, for example, even when storing into the image memory. Further, the image signal of the next frame is continuously being taken during the image processing of the data stored in the image memory.

In Step S12, the processing of “image switching output” is performed. In Step S12, the image switching circuit 17 switches the image signal from the DSP 11 and the mask image signal from the D/A converter 19 according to the image switching signal and supplies the image, for example, as the NTSC signal, and the operation proceeds to Step S2.

In Step S2, the next image data is taken and the above-mentioned processing will be repeated.

Namely, by finishing one screen according to the processing of Step S5 to Step S11, the mask data as shown in FIGS. 4A to 4E is formed as a mask image signal and the mask data is superimposed on the images of the ODD fields for the bright images in this embodiment.

In the first pattern view through the fifth pattern view of the respective FIGS. 4A to FIG. 4E, one of them is to be written into the image mask memory 15 and supplied as the mask data, in this embodiment. The optimum mask data to be written into the image mask memory 15, of the first pattern view to the fifth pattern view of FIGS. 4A to 4E, is decided as a result of the estimation of the experimental run previously.

In the first pattern view A to the fifth pattern view E of FIG. 4, gray square or rectangle portions are to be adjusted in the brightness, like white 100%, 50%, and 0%. The white 100% corresponds to the level 255 in the gradation of 256 levels. In FIG. 4, the gray square or rectangle portion becomes white in the case of white 100%. The white 50% means that the square or rectangle portion becomes gray, corresponding to the levels 127 to 128 in the gradation. The white 0% means that the square or rectangle portion becomes black, corresponding to the level 0 in the gradation.

Thus, the brightness of the mask is set. When the brightness is too high, since a difference of the gradation occurs between the ODD fields and the EVEN fields, it is important to set the brightness of the mask lower from a viewpoint of prevention of flickering.

Further, it is possible to adjust a gradation difference between the fields, by varying the format of the dots forming the mask, as shown in the first pattern view A to the fifth pattern view E of FIG. 4, for example, the size of the dot represented by the square or rectangle, and its array. In the first pattern view of FIG. 4A, the square dots are regularly aligned. In the second pattern view of FIG. 4B, the square dots are zigzag aligned. In FIG. 4C, the rectangle dots are regularly aligned. In FIG. 4D, the rectangle dots are zigzag aligned. In the fifth pattern view of FIG. 4E, the square dots and the rectangle dots are aligned in a mixed way.

Which one to be written into the image mask memory 15, of the first pattern view A to the fifth pattern view E, is previously estimated by the experiment, as mentioned above. When the screen of a monitor becomes larger, the mask pattern shows more clearly, and therefore, a smaller dot is desirable.

According to Step S5 to Step S11, a concept of the output of the image data and the superimpose data (mask data) for one screen is shown as FIGS. 5A and 5B respectively.

As shown in FIGS. 5A and 5B, the image data and the superimpose data have the same size of 512×512 bytes. In conjunction with the image synchronization signal, the data to be supplied is switched between the image data of A and the superimpose data of B and a composite image as the mask data is supplied.

The superimpose color data is set, for example, as FIG. 6A. FIG. 6A shows the color data on the left side, the memory stored data, and the color. The color data of white is defined as “1111111” and the memory stored data is defined as “7Fh”. The color data of gray is defined as “1000000” and the memory stored data is defined as “40h”. The color data of black is defined as “0000000” and the memory stored data is defined as “00h”.

The superimpose data here means the case of superimposing the data of 8 bits for one pixel, and the superimpose ON/OFF bit is attached to the upper one bit in addition to seven bits of the above color data. When the superimpose data is not read out, the upper one bit is defined as 0, while when it is read out, the upper one bit is defined as 1. The superimpose data for 512×512 bytes is written in a state as shown in FIG. 6B.

The address corresponding to the memory stored data is set in Step S4 of FIG. 3, and whether the upper one bit is 0 or 1 in FIG. 6B is checked in Step S8. When the upper one bit is 1, the superimpose data is read out in Step S9, while when it is 0, the image data is read out in Step S10. Thus, the mask image data is formed and the mask is superimposed on the images of the ODD fields, as mentioned above.

A signal output from the image processing unit 7 is supplied to the headup display 9 shown in FIG. 1. In the headup display 9, an image is displayed on the front window glass, and a driver of the car 1 can understand the situation ahead of the car properly even in a dark place at night by confirming the above image.

According to the processing of the flow chart of FIG. 3, it is possible to display one of the images of FIG. 7 to FIG. 9 by the headup display 9. FIG. 7 to FIG. 9 respectively show the examples of selecting the mask brightness of white 100%, 50%, and 0%, as mentioned in the mask patterns shown in FIG. 4A. The white portion in FIG. 7, the gray portion in FIG. 8, and the black portion in FIG. 9 respectively correspond to the mask portions.

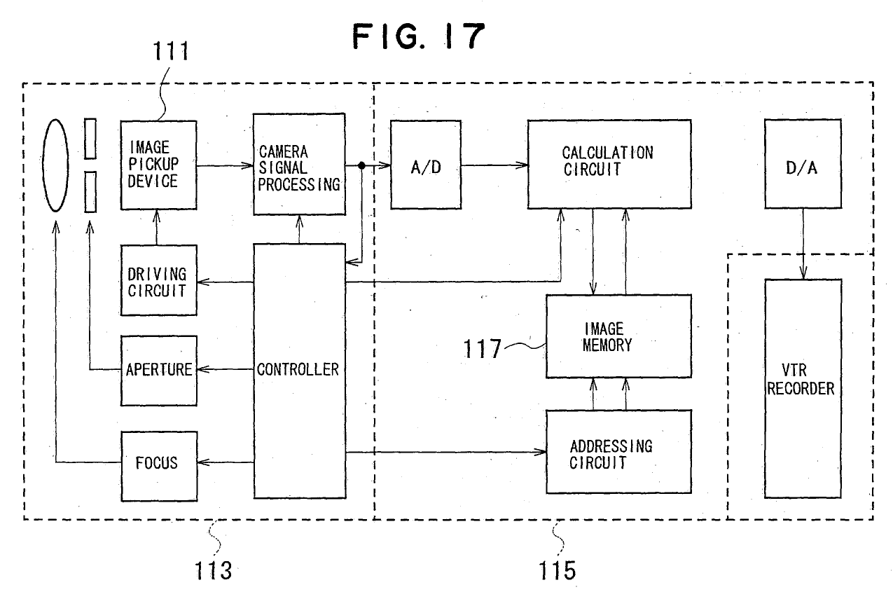

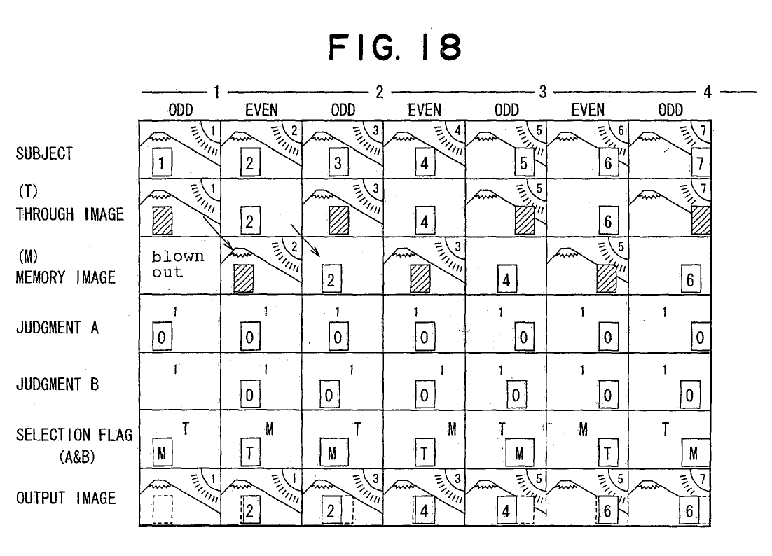

As apparent by a comparison with the output image according to the simple double exposure control of FIG. 16, the output images of FIG. 7 to FIG. 9 become sharp images without flicker on the screens. They show not only the information in the vicinity of the illuminant but also the dark portion sharper on the whole, by properly restraining the blooming (halation) due to a strong oncoming headlight, and the flicker is restrained.

As mentioned above, since the images of different light exposure amount are continuously and periodically supplied only under the simple double exposure control in FIG. 16, the output image suffers flicker as shown in FIG. 16. On the contrary, according to the first embodiment of the invention, a mask is superimposed on, for example, the images of the ODD fields, thereby lowering the brightness level of the ODD fields. Therefore, a gradation difference between the ODD fields and the EVEN fields is restrained and the image free from flicker as shown in FIG. 7 to FIG. 9 can be supplied.

In the output images of FIG. 7 to FIG. 9, since a gradation difference between the ODD fields and the EVEN fields can be restrained by superimposing the mask, sharper images free from flicker with no boundary can be obtained, compared with the case of partially combining the images of different light exposure amount with each other.

Here, a driver can select his or her favorite output image of FIG. 7 to FIG. 9 according to his or her taste. Therefore, a selection button may be provided for a driver to select the mask data in his or her own judgment, thereby expanding the versatility.

[Second Embodiment]

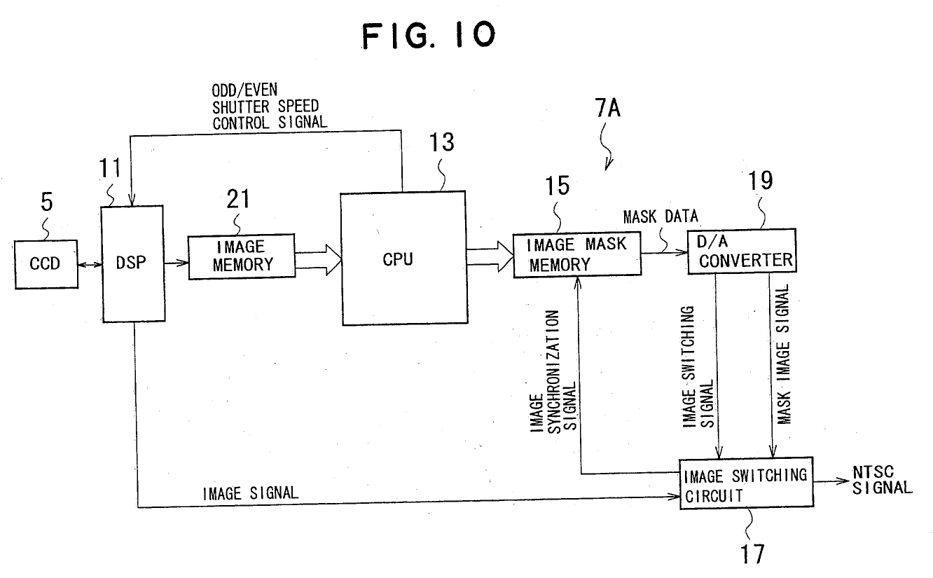

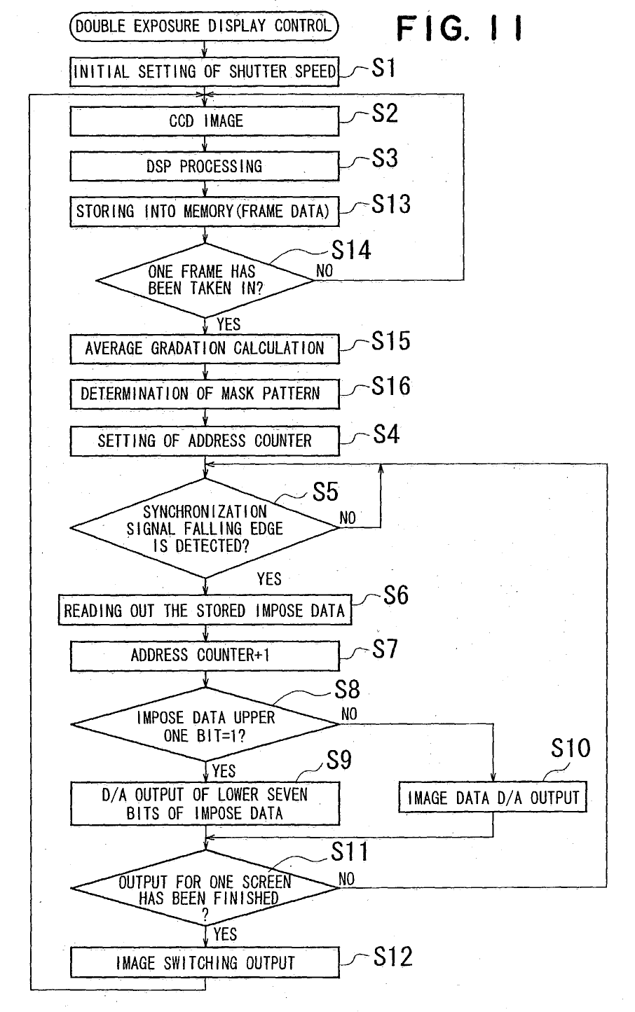

FIG. 10 and FIG. 11 show a second embodiment of the invention. FIG. 10 is a block diagram of an imaging system according to the second embodiment and FIG. 11 is a flow chart. The same reference numerals are attached to the same components corresponding to the first embodiment.

In this embodiment, a mask is changed according to the gradation average of the whole screen formed by the images of different light exposure amount, so as to adjust the brightness level between the ODD fields and the EVEN fields.

The imaging system of this embodiment adds an image memory 21 to the image processing unit 7A as shown in FIG. 10.

The image data output from the DSP 11 is once stored into the image memory 21, the CPU 13 calculates the average gradation on the whole screen for one frame, and the mask to be written into the image mask memory 15 is changed depending on the average gradation. This change of the mask means, for example, the change of the brightness of the mask pattern, the size of the dot, and the array of the dots, as shown in FIG. 4.

For example, when the average gradation on the whole screen is brighter, the brightness of the mask pattern is set a little darker. When the average gradation on the whole screen is darker, the brightness of the mask pattern is set a little brighter. When the average gradation is brighter, the dots of the mask pattern are set finer. When the average gradation is darker, the dots of the mask pattern are set rougher. These can restrain the gradation difference between the ODD fields and the EVEN fields assuredly.

The imaging system of this embodiment is operated according to the flow chart of FIG. 11. The flow chart of FIG. 11 is basically the same as the flow chart of FIG. 3 in the first embodiment, and the same step numbers are attached to the corresponding steps.

In the flow chart of FIG. 11 according to this embodiment, Step S13, Step S14, Step S15, and Step S16 are added between Step S3 and Step S4.

In FIG. 11, when the operation moves to Step S13 after passing through Steps S1, S2, and S3, the processing of “storing into memory” is performed, the processed signal output from the DSP 11 is stored into the image memory 21, and the operation proceeds to Step S14.

In Step S14, the processing of “whether one frame has been taken in or not” is performed, and it is checked whether the processed signal output from the DSP 11 for one frame has been stored into the image memory 21 or not. When one frame has not been stored in the image memory 21, this step is returned to Step S2, and the processing of Step S2, step S3, Step S13, and Step S14 will be repeated. In Step S14, when it is judged that the processed signal for one frame has been all stored, the operation proceeds to Step S15.

In Step S15, the processing of “average gradation calculation” is performed. In Step S15, the average gradation of the whole image data for one frame stored into the image memory 21 is calculated and the operation proceeds to Step S16.

In Step S16, the processing of “determination of mask pattern” is performed. In Step S16, the mask pattern is determined according to the average gradation on the whole screen. Namely, the mask pattern, the mask brightness, the size of the dot, and the array of the dots, as shown in FIG. 4, are determined, and the mask pattern is written into the image mask memory 15 depending on the determination.

Step S4 to Step S12 are performed in the same way as in the first embodiment.

Accordingly, also in this embodiment, the image signal from the DSP 11 and the mask image signal from the D/A converter 19 are switched and supplied. For example, the mask data of the patterns as shown in FIG. 4 is properly selected and superimposed on the ODD fields, thereby reducing the gradation difference between the both fields and restraining the flicker on the whole screen.

Since the mask is changed according to the average gradation on the whole screen in this embodiment, it is possible to restrain the gradation difference between the both fields and prevent the flicker more assuredly.

There is a DSP 11 for processing the electric charge for every pixel that can read out the electric charges of not only the single pixel but also a lump of some pixels, in the ODD fields and the EVEN fields.

In the embodiment, although the mask is superimposed on the images of the ODD fields, as far as the mask is used to restrain the gradation difference between the ODD fields and the EVEN fields, it may be superimposed on the images of the EVEN fields when the images of the EVEN fields are bright as a result of changing the shutter speed.

In the above embodiment, although the output image is displayed on the headup display 9, it may be displayed on a display provided inside the car. Further, although the forward direction ahead of the car in the running direction is illuminated by the IR, lamp 3, the rear or the lateral side may be illuminated.

The imaging system may be adopted to not only a car but also a two-wheeled vehicle, a marine vessel, and the other transport, or it may be formed as an imaging system independent of the transport.

What is claimed is:

1. An imaging system comprising:
infrared ray illuminating means for radiating an infrared ray;
imaging means for taking an image of a place illuminated by the infrared ray illuminating means and converting the image into an electric signal; and
an image processor for varying signal accumulating time of the imaging means at a predetermined cycle and continuously and periodically forming images of different light exposure amount, wherein
the image processor sets a mask for adjusting a brightness level between the images of different light exposure amount.

2. The imaging system, according to claim 1, wherein
the image processor sets the mask on the image of the higher brightness level, of the images of different light exposure amount.

3. The imaging system, according to claim 1 or 2, wherein
the image processor adjusts the brightness level, according to the brightness of the mask or a format of each dot forming the mask.

4. The imaging system, according to claims 1 to 3, wherein
the image processor changes the mask, according to an average gradation on the whole screen formed by the images of different light exposure amount, hence to adjust the brightness level.

5. The imaging system, according to one of claims 1 to 4, wherein
the infrared ray illuminating means, the imaging means, and the image processor are provided in a car,
the infrared ray illuminating means illuminates an outside of the car with the infrared ray, and
the imaging means takes an image of the outside of the car.
